(19) United States
(12) Patent Application Publication
(10) Pub. No.: US 2022/0082224 A1
(43) Pub. Date: Mar. 17, 2022

(54) IGNITABLE ELECTRONIC CANDLE

(71) Applicant: Bella iLighting Inc., Temple City, CA (US)

(72) Inventor: Kwing Shui M. Cho, Chino Hills, CA (US)

(21) Appl. No.: 17/022,544

(22) Filed: Sep. 16, 2020

(51) Int. Cl. F21S 19/00; F21V 23/04; F21S 9/02; F21V 8/00; F21V 37/00

(52) U.S. Cl. CPC F21S 19/00; F21V 23/0435; F21Y 2115/10; G02B 6/0005; F21V 37/00; F21S 9/02

(57) ABSTRACT

An ignitable electronic candle including a candle body and an electronic luminous part is provided. The electronic luminous part that includes a light-transmitting shield, a first luminous body, an electronic control unit and a power supply is set below the candle body. The first luminous body is located near the center of the lower surface of the light-transmitting shield. A light guide body wrapped in an ignitable sleeve is installed in the middle of the upper surface of the light-transmitting shield. The light guide body and the ignitable sleeve pass through the candle body above the light-transmitting shield and extend out of the upper surface of candle body. The first luminous body is electrically connected with the power supply through the electronic control unit. The ignitable sleeve can be lit like a candle wick to make the electronic candle function as a traditional candle.

### TECHNICAL FIELD

The present disclosure relates generally to candles, and more specifically to electronic candles that can also be lit up like a traditional candle.

### BACKGROUND

Future Electronic candles—that boast increased safety, convenience, energy efficiency and environmental friendliness—have become more and more popular and are gradually replacing traditional flame rod candles, especially in European and North American countries.

However, traditional flame rod candles remain popular due to the appeal of natural flame. Although existing electronic candles have an electronic control circuit, the control function is simple, and the lighting effect does not resemble natural flame. Despite the inclusion of a timing function, the design of most electronic candles is not user friendly, the energy consumption is high, and the lighting effect of the candle is not natural. Thus, current electronic candles are unable to compete with traditional flame rod candles.

In addition, a light bead or bulb is often used as the flame front of most of traditional electronic candles. Such simulation effect does not appear natural and the visual effect is not pleasing. At the present, electronic candles also cannot realize the multi-dimensional and multi-level stereoscopic lighting effects achievable with natural flame, and cannot satisfy the consumer demand for traditional flame lighting.

### SUMMARY

The technical problem to be solved in the disclosure is to provide an ignitable electronic candle that can provide electric lighting as well as traditional flame lighting, solving the problems of prior art electronic candles, such as overly simple functions and single usage, and improving the non-ideal lighting effect of traditional electronic candles.

The technical solutions provided in the disclosure are as follows:

An ignitable electronic candle including a candle body is provided. The electronic luminous part, including a light-transmitting shield, a first luminous body, an electronic control unit and a power supply, is set below the candle body. The first luminous body is close to the middle of the lower surface of the light-transmitting shield. The light guide body that is wrapped with an ignitable sleeve is affixed in the middle of the upper surface of the light-transmitting shield. The light guide body and the ignitable sleeve pass through the candle body located above the light-transmitting shield and jut out the upper surface of candle body. The light emitted by the first luminous body radiates below the light guide body through the light-transmitting shield. The light guide body guides the light to the top of the electronic candle. The first luminous body is electrically connected with the power supply through the electronic control unit.

In some embodiments, the light-transmitting shield is made of one or more flame-retardant insulating materials, and the light guide body is made of an optical fiber.

In some embodiments, a sunken or curved structure or a slab/flat structure is formed in the middle of the light-transmitting shield. A fixed sleeve that is used for fixing the light guide body is set in the middle of the light-transmitting shield. The fixed sleeve and the first luminous body are located on the same vertical center line.

In some embodiments, the candle body is made of a mixture of paraffin and microcrystalline wax.

In some embodiments, the light-transmitting shield is made of non-ferrous materials.

In some embodiments, the ignitable sleeve extends above the fixed sleeve along the top of the light guide body, and the ignitable sleeve is a woven cotton sleeve or paper sleeve.

In some embodiments, the electronic luminous part also includes several second luminous bodies set below the light-transmitting shield, and the second luminous body is connected with the first luminous body in parallel. The second luminous body is used with the colorful LED light beads integrated with red light, green light and blue light cores, and the electronic control unit controls the colorful LED light beads for adjustment of lighting color.

In some embodiments, the control switch is installed at the bottom of the electronic luminous part and is electrically connected with the power supply, which may be a dry battery or rechargeable battery that is detachable and replaceable.

In some embodiments, the electronic control unit is electrically connected with a remote-control module that communicates wirelessly with an external remote control. The remote control is equipped with a switch button, multiple sets of dimming buttons and multiple sets of timing buttons.

In some embodiments, the candle body is externally covered with a candle cup. The bottom of the candle cup is equipped with a fixed opening that accommodates the electronic luminous part.

Compared with existing technology, the beneficial effects of the electronic candle disclosed herein are as follows:

(1) The ignitable electronic candle taught in the present disclosure can provide not only electric lighting but also traditional flame lighting, improving the overly simple functions and non-ideal lighting effects of a conventional electronic candle through an ignitable sleeve that is wrapped around a light guide body in conjunction with the electric lighting of the electronic luminous part.

(2) The ignitable electronic candle in the disclosure generates ambient light using the electronic luminous part and the ambient light is projected through the translucent candle body to create a pleasing effect. In addition, the top wick can be ignited through the light guide body to achieve a multi-dimensional and multi-level stereoscopic lighting effect through the candle body.

(3) The light transmitting shield in the ignitable electronic candle in the present disclosure can prevent the candle body from dropping into the electronic luminous part during burning and from melting into the light-transmitting shield. The light transmitting shield can also prevent the frame around the electronic luminous part from damaging the electronic equipment. As such, the electronic equipment below the light-transmitting shield can last for a long time, while the candle body and the ignitable sleeve coupled with the light guide body are replaceable. When the old candle body is replaced with a new candle body, the light-transmitting shield can be cleared to accept the new candle body being installed on it. The new candle body and the first luminous body align with the position of the light guide body. The electronic candle becomes usable again.

(4) The ignitable electronic candle in the present disclosure can collect not only condensation through the sunken or curved structure of the light-transmitting shield, but also the melt wax when the candle body is burning. The sunken or curved structure can also be used to prevent the candle body from falling off when the electronic luminous part is disassembled from the light-transmitting shield; In addition, the light beads are provided with a colorful, integrated design to adjust the light color as desired and to improve the aesthetic appearance of the illumination effect of the electronic candle.

### DESCRIPTION OF THE DRAWINGS

FIG. 1 is a schematic diagram of the overall structure of the ignitable electronic candle disclosed in the present application;

FIG. 2 is a schematic diagram of the overall structure of another example of the ignitable electronic candle disclosed in the present application;

FIG. 3 is an enlarged view of the structure of a light guide body and an ignitable sleeve used in the ignitable electronic candle;

FIG. 4 is an enlarged view of the structure of the second luminous body of the ignitable electronic candle;

FIG. 5 is a schematic diagram of a remote control of the ignitable electronic candle in the disclosure.

The attached drawing is labeled as follows:

1. Candle body; 2. Fixed sleeve; 3. Light-transmitting shield; 4. The first luminous body; 5. Electronic control unit; 6. Power supply; 7. Light guide body; 8. Ignitable sleeve; 9. Control switch; 10. Remote control module; 11. Remote control; 12. Switch button; 13. Dimming button; 14. Timing button; 15. The second luminous body; 20. Electronic luminous part 20.

### DETAILED DESCRIPTION

Next, the disclosure is further described in detail in combination with the attached drawings and examples. It shall be understood that the specific example described here is only used to explain embodiments and preferred modes, not to limit the disclosure in any way.

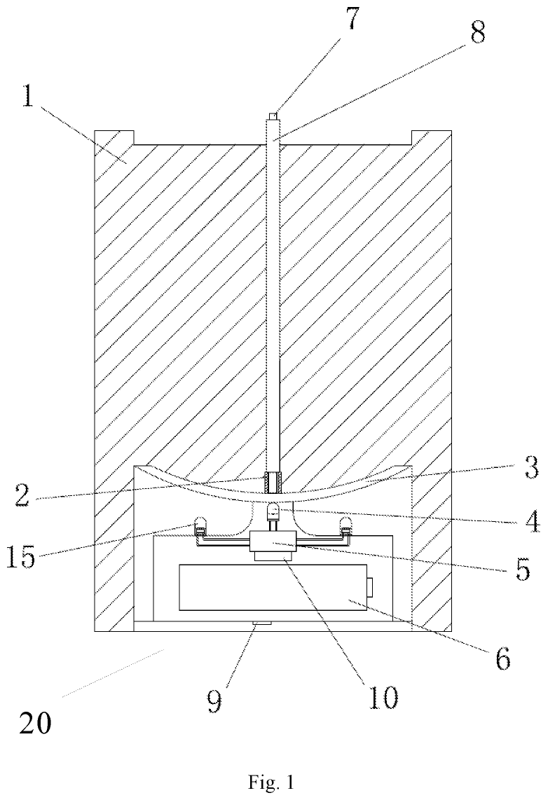

As shown in FIG. 1-5, an ignitable electronic candle including a candle body 1 is provided. The electronic luminous part 20, including the light-transmitting shield 3, the first luminous body 4, the electronic control unit 5 and the power supply 6, is set below the candle body 1. The first luminous body 4 is close to the center of the lower surface of the light-transmitting shield 3. The light guide body 7 that is externally wrapped with the ignitable sleeve 8 is affixed in the center of the upper surface of the light-transmitting shield 3. The light guide body 7 and the ignitable sleeve 8 pass through the candle body 1 above the light-transmitting shield 3 and extend out of the upper surface of the candle body 1. The light emitted by the first luminous body 4 enters the light guide body 7 through the light-transmitting shield 3. The light guide body 7 transmits or guides the light to the top of the electronic candle. The first luminous body 4 is electrically connected to the power supply 6 through the electronic control unit 5.

The candle shown in FIG. 1 can function not only as an electric lamp, but also as traditional ignition or flame candle through the ignitable sleeve 8 wrapped around the light guide body 7. The ignitable sleeve 8 can be lit similarly to a traditional candle wick. The lighting from the electronic luminous part 20 can be combined with the flame lighting of the ignitable sleeve 8. The first luminous body 4 emits light to the top of light guide body 7 for direct light and radiates light on or through the candle body to form ambient light. The light-transmitting shield 3 can isolate the candle drops during burning and shield the electronic elements in the electronic luminous part 20 from flames that could cause damage.

When the electronic candle is in use, the first luminous body 4 is powered on and emits light from the bottom of the light guide body 7 that is located above the light-transmitting shield 3. The light is transmitted to the top of the electronic candle through the light guide body 7 as light source. In addition, the ignitable sleeve 8 wrapped outside the light guide body 7 can be ignited. The flame temperature of the ignitable sleeve 8 when burning is higher than the melting point of the light guide body 7 and lower than the ignition point of the light guide body 7, so the light guide body 7 will not be ignited, only softened or melt in the burning process of the candle body 1 and the ignitable sleeve 8. When the candle is blown out, the light guide body 7 quickly solidifies. The top of the electronic candle can still be translucently lit without affecting the continued use of electronic candle. Only the brightness is changed.

In some examples of the disclosure, the light-transmitting shield 3 is made of flame-retardant insulating glass sheet or plastic sheet, and the light guide body 7 is made of optical fibers. The light-transmitting shield 3 is designed to transmit the light emitted by the first luminous body 4 into the light guide body 7, and radiate the light onto the candle body 1 through the light-transmitting shield 3. In this way, the electronic candle expands the illumination scope of the ambient light, differentiates the illumination intensities of the two light sources, and creates a layered effect for the candle.

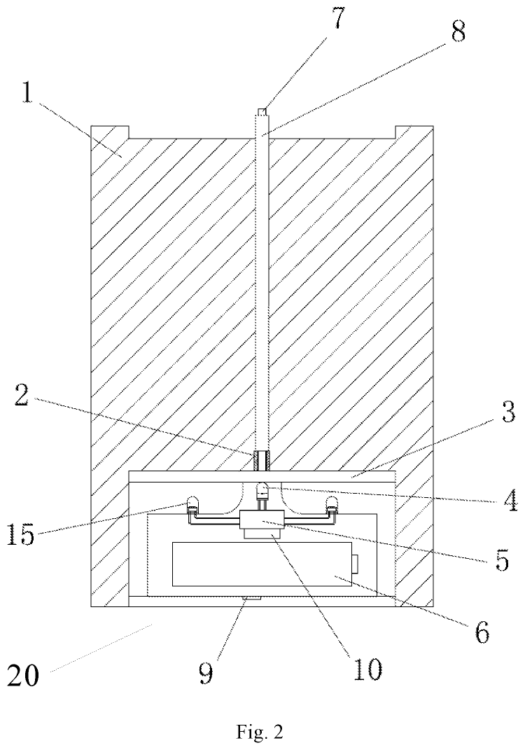

In some examples of the disclosure, a middle sunken structure or flat structure is used in the light-transmitting shield 3. FIG. 1 shows a curved light transmitting shield 3 with a sunken or lower middle portion. In comparison, FIG. 2 shows a flat light transmitting shield 2. The fixed sleeve 2 used for fastening the light guide body 7 is set in the middle of the light-transmitting shield 3. The fixed sleeve 2 and the first luminous body 4 are located on the same vertical center line. Therefore, the light guide body 7 can be rapidly aligned and placed in the fixed sleeve 2 in the follow-up disassembly and assembly processes, in order to achieve the precise positioning of the light guide body 7 and the first luminous body 4 and to ensure the maximum luminosity at the top of the light guide body 7.

In some examples of the disclosure, the candle body 1 is made of a mixture of paraffin and microcrystalline wax, or a mixture of paraffin and soy wax. The microcrystalline wax or soy wax is used to improve the transparency of the candle body 1 and the light-transmitting effect.

In some examples of the disclosure, the glass sheet or plastic sheet is made of non-ferrous materials. A certain color may be added through the light-transmitting shield 3 so that the light-transmitting effect of the first luminous body 4 can be instantly changed, and different ambient light effects can be achieved.

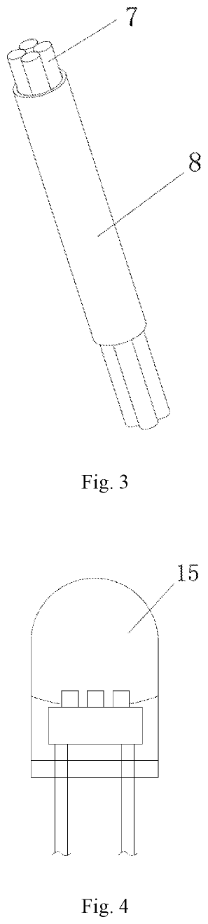

In some examples of the disclosure, as shown in FIG. 1 and FIG. 3, the ignitable sleeve 8 is extended above the fixed sleeve 2 along the light guide body 7 to reach the top. The ignitable sleeve 8 may be a woven cotton sleeve or paper sleeve.

The ignitable sleeve 8 is cut off above the fixed sleeve 2 to ensure the sufficient burning of the above candle body 1. After the flame has reached to the end of the ignitable sleeve 8, because the ignition point of the general optical fiber and the light guide body 7 is higher than the flame temperature of the candle, the burning stop for lack of ignition source, i.e., the top candle body 1 and ignitable sleeve 8 are burnt out and the light guide body 7 stops burning. The end of the light guide body 7 is installed in the fixed sleeve 2, and the top of the light guide body 7 still emits light without affecting the continued use of the electronic candle.

In some examples of the disclosure, as shown in FIG. 4, the electronic luminous part 20 also includes several second luminous bodies 15 set below the light-transmitting shield 3. The second luminous body 15 is connected with the first luminous body 4 in parallel. The second luminous body 15 may be used with colorful LED light beads integrated with red light, green light and blue light (RGB) cores. The electronic control unit 5 controls the colorful LED light beads for adjustment of light color.

The LED light bead with three-color cores can be used with the single-color lighting switch. The light bead can also achieve the combined, colorful lighting effect of the RGB cores, greatly improving the aesthetics of the candle's ambient effect.

In some examples of the disclosure, the control switch 9 is installed at the bottom of the electronic luminous part 20 and is electrically connected with the power supply 6. The power supply 6 may be a dry battery or rechargeable battery and can be detachable and/or replaceable.

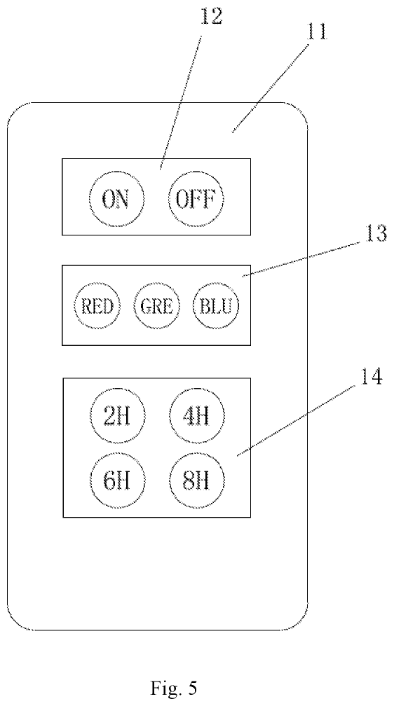

In some examples of the disclosure, as shown in FIG. 1 and FIG. 5, the electronic control unit 5 is electrically connected with the remote-control module 10. The remote-control module 10 is wirelessly connected to an external remote control 11, which is equipped with the switch button 12, multiple sets of dimming buttons 13 and multiple sets of timing buttons 14. The multiple sets of dimming buttons 13 can individually control or compositely control the RGB light sources to achieve colorful lighting effect.

In some examples of the disclosure, the candle body 1 is externally covered with a candle cup (not shown). The bottom of the candle cup is equipped with a fixed opening to accommodate the electronic luminous part 20.

An external container (not shown) is added outside the candle body 1 to improve the overall packaging and appearance of the electronic candle. After the candle body 1 is burnt through, the candle body 1 and the light guide body 7 wrapped with the ignitable sleeve 8 can be replaced. The candle cup and the electronic luminous part 20 can be reused to lengthen product lifetime and reduce costs.

In conclusion, the ignitable electronic candle disclosed herein has a novel structure with a simple operation. The ignitable electronic candle also is low costs and has a long service life and improved lighting effect and appearance. It can provide electric lighting and traditional flame lighting with reusable and replaceable parts to reduce manufacturing cost and lower consumer price.

It shall be noted that certain implementation modes that are not shown in the drawings or described in the specification is known by those skilled in in the technology field, therefore is not described in detail. In addition, the components and processes described herein are not limited to the specific structures, shapes or modes mentioned in the examples.

It shall be noted that illustrations using specific values of certain parameters are provided in the present disclosure. These parameters are given approximate values, and similar values within an acceptable error margin or a design constraint can be used as well. The terms of directions mentioned in the example, such as “above”, “below”, “front”, “back”, “left” and “right”, are only the directions in the attached drawing, but are not used to restrict the scope of protection in the application.

The above description shows and describes some preferred examples. As previously mentioned, it shall be understood that the disclosure is not limited to the exact forms or structures disclosed in the paper, and should not be construed to eliminate other examples. It can be used in other combinations, modifications and environments, and can be altered through above instructions or known technology or common knowledge in relevant fields within the scope of disclosed conception in the present application. The alteration and change made by those skilled in the art that are not distinctive in the spirit and scope of the disclosure should be considered as within the scope of the disclosure.

What is claimed is:

1. An ignitable electronic candle comprising:
a candle body;
a light guide body wrapped in an ignitable sleeve;
an electronic luminous part, wherein the electronic luminous part comprises a light transmitting shield, a first luminous body, an electronic control unit, and a power supply;
wherein the electronic luminous part is located below the candle body and near the center of the lower surface of the light transmitting shield;
wherein the light guide body is located in the middle of the upper surface of the light transmitting shield, and the light guide body and the ignitable sleeve pass through the candle body and extend out of an upper surface of the candle body; and
wherein the first luminous body is electrically connected with the power supply through the electronic control unit.

2. The ignitable electronic candle of claim 1, wherein the light transmitting shield is made of a flame-retardant insulating material and the light guide body is made of an optical fiber.

3. The ignitable electronic candle of claim 2, wherein the light transmitting shield comprising a slot in the center and a fixed sleeve located in the slot for fastening the light guide body, wherein the fixed sleeve and the first luminous body are aligned along a vertical center line.

4. The ignitable electronic candle of claim 1, wherein the candle body is made of a mixture of paraffin and microcrystalline wax.

5. The ignitable electronic candle of claim 2, wherein the light transmitting shield is made of non-ferrous materials.

6. The ignitable electronic candle of claim 3, wherein the ignitable sleeve extends from the fixed sleeve to the top of the light guide body.

7. The ignitable electronic candle of claim 1, wherein the electronic luminous part further comprises one or more second luminous bodies made of colorful LED light beads, wherein the one or more second luminous bodies are located below the light transmitting shield and are connected with the first luminous body in parallel.

8. The ignitable electronic candle of claim 1, further comprising a control switch at the bottom of the electronic luminous part, wherein the control switch is electronically connected with a power supply,

9. The ignitable electronic candle of claim 8, wherein the power supply is a dry battery or a rechargeable battery and the dry battery or rechargeable battery is either detachable or replaceable.

10. The ignitable electronic candle of claim 8, wherein the electronic control unit can be remotely controlled via a remote control, and wherein the remote control comprises a switch, one or more dimming control buttons, and one or more timing control buttons.

11. The ignitable electronic candle of claim 1, further comprising a candle cup, wherein the candle cup is used to cover the candle body and is configured with an opening at the bottom to accommodate the electronic luminous part.
